(19) United States
(12) Patent Application Publication
(10) Pub. No.: US 2011/0102633 A1
(43) Pub. Date: May 5, 2011

(54) IMAGE SENSING APPARATUS

(75) Inventor: YUICHI HIRAI, Tokyo (JP)

(73) Assignee: CANON KABUSHIKI KAISHA, Tokyo (JP)

(21) Appl. No.: 13/005,172

(22) Filed: Jan. 12, 2011

Related U.S. Application Data
(62) Division of application No. 11/776,934, filed on Jul. 12, 2007.

(30) Foreign Application Priority Data
Jul. 13, 2006 (JP) 2006-193232

(51) Int. Cl. H04N 5/76

(52) U.S. Cl. 348/231.3; 348/E05.024

(57) ABSTRACT

An image sensing apparatus includes a hash calculation unit which calculates a digest value from group image data including two or more image data; and an alteration detecting information generating unit which generates alteration detecting information from the digest value.

### CROSS-REFERENCE TO RELATED APPLICATIONS

This application is divisional of application Ser. No. 11/776,934, filed Jul. 12, 2007, the entire disclosures of which is hereby incorporated by reference.

### BACKGROUND OF THE INVENTION

1. Field of the Invention

The present invention relates to an apparatus, method and computer program capable of generating alteration detecting information which is used to detect whether or not image data is altered.

2. Description of Related Art

As is conventionally well known, a digital camera having a semiconductor image sensing element such as a CCD or C-MOS sensor has a function of receiving a moving image signal or a still image signal as an image signal, digitizing the signal, and storing the image data in a storage medium such as a semiconductor memory. Along with the recent progress of semiconductor technologies, semiconductor image sensing elements with, for example, 6,000,000 pixels to more than 10,000,000 pixels have been developed and used. Hence, the quality of image data sensed by digital cameras including such a semiconductor image sensing element with an enormous number of pixels is improving remarkably. Some digital cameras are consequently making an entry into fields where silver halide cameras were formerly used. For example, digital cameras are used to take photographs to be published in newspapers and magazines or to take identification photographs.

While the digital cameras are finding such new application fields, the focus falls on handling of photographs as distribution items and the believability of the photographs themselves. Image data is an electrical signal and is therefore alterable more easily than photographs created by a silver halide camera. Without a solution to this problem, image data whose believability is uncertain is unacceptable as formal evidence.

There are conventionally several proposals about how to generate, sign, and record alteration detecting data for image data sensed by a digital camera. For example, Japanese Patent Laid-Open No. 2002-010044 discloses an invention that stores image data in an image area and signature data in a property area in saving generated image file data in a recording medium.

FIG. 1 is a block diagram showing an example of an alteration detecting information generating unit of prior art. Referring to FIG. 1, a processing unit 101 controls the overall device and normally includes a CPU and a ROM that stores a control program to control the overall device. The processing unit 101 controls shooting processing, development processing, and image file data generation processing. FIG. 1 does not illustrate parts necessary for shooting processing. A work memory 105 in FIG. 1 stores, as image file data A, B, and C, image data as a processing target obtained from an image sensing unit (not shown).

A file management register 102 in FIG. 1 holds the attributes (e.g., size and storage address) of each image file data. The processing unit 101 reads out the attributes of image file data as a processing target from the file management register 102 and transfers them to a memory control register 103. The memory control register 103 stores the received attributes of image file data.

The memory control register 103 designates, to a memory control unit 104, the address and size of image file data to be read out. The memory control unit 104 controls to issue “status” to the work memory 105 and actually reads or writes the image file data from or to the work memory 105.

Referring to FIG. 1, a hash calculation unit 106 executes hash calculation. Hash calculation is commonly used as an alteration detecting means. A hash function is a one-way function which obtains operand data (input message: image file data in this case) from the result of the function. Before processing, the processing unit 101 initializes the hash calculation unit 106.

Image file data read out from the work memory 105 is transferred to the hash calculation unit 106 and subjected to hash calculation. A signature calculation unit 107 uses a processing method such as SHA1. The signature calculation unit 107 signs the processing output result (to be referred to as a digest value hereinafter) from the hash calculation unit 106 by using key information unique to a device (e.g., digital camera with specified model name and serial number). Hence, when signature data unique to a digital camera (device) is added to image data (file) obtained upon shooting by the digital camera (device), the image file data can safely be extracted from the digital camera (device) and taken out.

The hash calculation unit 106 described with reference to FIG. 1 must execute hash calculation of an input message (image file data) a plurality of number of times. The throughput of the digital camera drops only via the hash calculation unit 106. For example, an MD5 Message-Digest Algorithm (to be referred to as an “MD5 algorithm” hereinafter) requires four operations of hash calculation per word of an input message. That is, even when an operation of hash calculation is executed in a clock as hardware processing, the processing time increases to four times for an input message. For this reason, it is difficult for, for example, a digital camera that implements high-speed continuous shooting to control to generate alteration detecting digest values simultaneously with high-speed continuous shooting.

### SUMMARY OF THE INVENTION

The present invention is directed to overcome the above-described drawbacks and disadvantages.

The present invention is directed to generate alteration detecting information, which is used to detect whether or not image data is altered, more rapidly or efficiently.

According to an aspect of the present invention, there is provided an image sensing apparatus comprising: a hash calculation unit which calculates a digest value from group image data including two or more image data; and an alteration detecting information generating unit which generates alteration detecting information from the digest value.

According to another aspect of the present invention, there is provided an image sensing apparatus comprising: a hash calculation unit which calculates a digest value from two or more partial image data extracted from image data; and an alteration detecting information generating unit which generates alteration detecting information from the digest value.

Further features and aspects of the present invention will become apparent from the following description of exemplary embodiments with reference to the attached drawings.

### BRIEF DESCRIPTION OF THE DRAWINGS

FIG. 1 is a block diagram of the main part of an alteration detecting information generating unit according to a prior art;

FIG. 2 is a block diagram of the main part of an alteration detecting information generating unit applied to a digital camera according to a first exemplary embodiment of the present invention;

FIG. 3 is a block diagram of the main part of an alteration detecting information generating unit applied to a digital camera according to a second exemplary embodiment of the present invention;

FIGS. 4A, 4B, 4B′, 4C and 4D are views for explaining the contents of registers included in the alteration detecting information generating unit of the digital camera according to the first and second exemplary embodiments of the present invention; and

FIG. 5 is a flowchart for explaining the operation of the alteration detecting information generating unit according to the first embodiment of the present invention.

### DESCRIPTION OF THE EMBODIMENTS

Exemplary embodiments, features and aspects of the present invention will now be described in detail below with reference to the attached drawings.

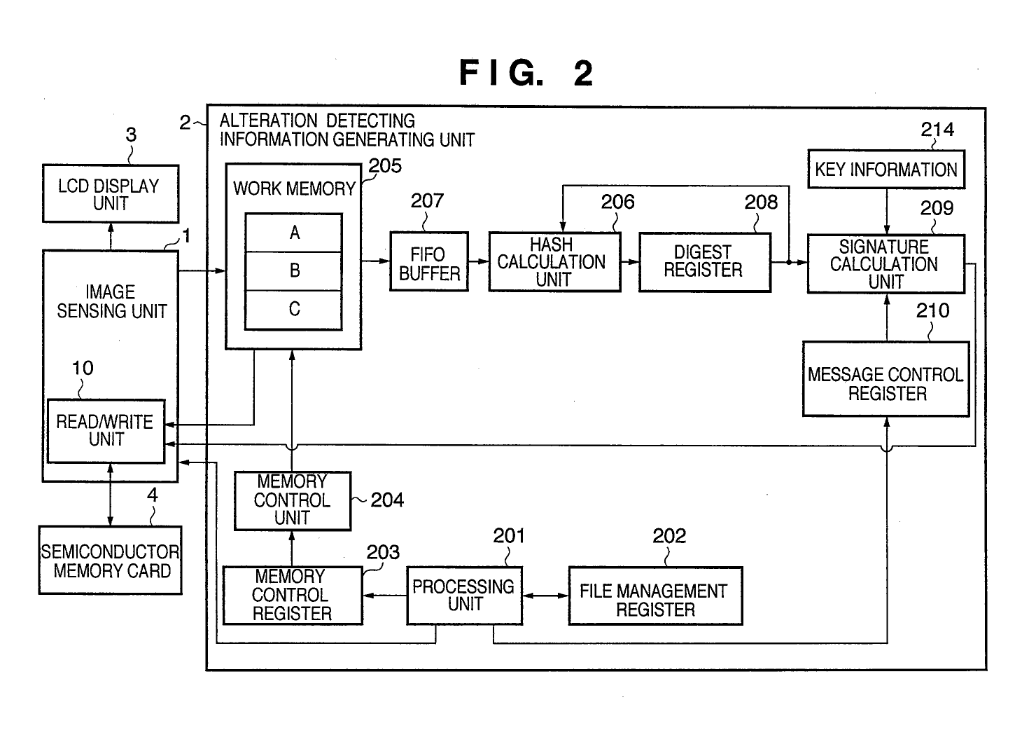

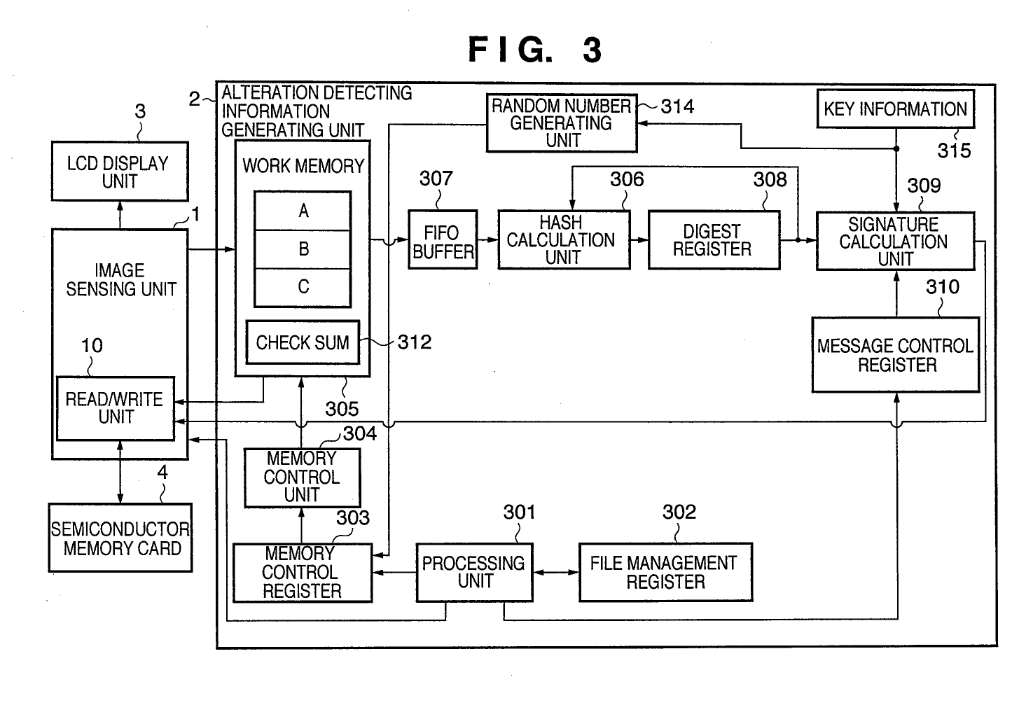

Two exemplary embodiments that apply the present invention to a digital camera will be described with reference to FIGS. 2 and 3. The first exemplary embodiment shown in FIG. 2 mainly exemplifies a case where a digest value is calculate from group image file data including a plurality of image data files not to impede control of high-speed continuous shooting of a digital camera. The second exemplary embodiment shown in FIG. 3 exemplifies a case where a digest value is calculate from a partial image data file obtained by selecting or deleting a part of image file data, thereby speeding up the hash calculation.

### First Exemplary Embodiment

FIG. 2 is a block diagram of the main part of a digital camera according to the first exemplary embodiment of the present invention. The digital camera shown in FIG. 2 is one example of an image sensing apparatus, and is also one example of an alteration detecting information generating apparatus. Referring to FIG. 2, the digital camera includes an image sensing unit 1, alteration detecting information generating unit 2, LCD display unit 3, and detachable semiconductor memory card 4. The alteration detecting information generating unit 2 generates alteration detecting information from image data provided from the image sensing unit 1. The alteration detecting information is used to detect an alteration of the image data. The LCD display unit 3 is provided to monitor an object image before or after shooting or image data stored on the semiconductor memory card 4. The image sensing unit 1 including an optical system, semiconductor image sensing element, signal processing circuit, and digital conversion circuit outputs image data representing a sensed image. A detailed description of these components and their operations will be omitted in this specification.

In the first exemplary embodiment, hash calculation of image data (image file data) will be described in detail. Other operations including image sensing and development processing are well known, and a detailed description thereof will not be given.

Image file data A and B obtained by the image sensing unit 1 of the digital camera are temporarily stored in a volatile memory such as a DRAM serving as a temporary storage means until they are finally recorded on a nonvolatile memory such as the semiconductor memory card 4. A work memory 205 serves as such temporary storage means. Image file data is not only recorded on a recording medium such as an HDD or magnetooptical disk but may also be transferred to an external storage device via an I/F (not shown) provided on the digital camera.

In the alteration detecting information generating unit 2 shown in FIG. 2, a processing unit 201 controls the digital camera and normally includes a CPU (central processing unit) and a ROM (read only memory) that stores a control program to control the digital camera. The processing unit 201 executes control of shooting processing, development processing, and image file data generation processing, including control of the image sensing unit 1. As described above, the work memory 205 in FIG. 2 temporarily stores, as the image file data A, B and C, image data as a processing target obtained from the image sensing unit 1.

A file management register 202 holds the attributes (e.g., size and storage address) of each image file data. The file management register 202 may be allocated in the work memory 205. The processing unit 201 reads out the attributes of image file data as a processing target from the file management register 202 and transfers them to a memory control register 203. The memory control register 203 stores the received attributes of image file data.

The memory control register 203 designates, to a memory control unit 204, the address and size of image file data to be read out. The memory control unit 204 controls to issue “status” to the work memory 205 and actually reads or writes the image file data from or to the work memory 205.

If a setting on the digital camera requests addition of alteration detecting information, a digest value is calculated from group image file data including two or more target image file data obtained upon shooting.

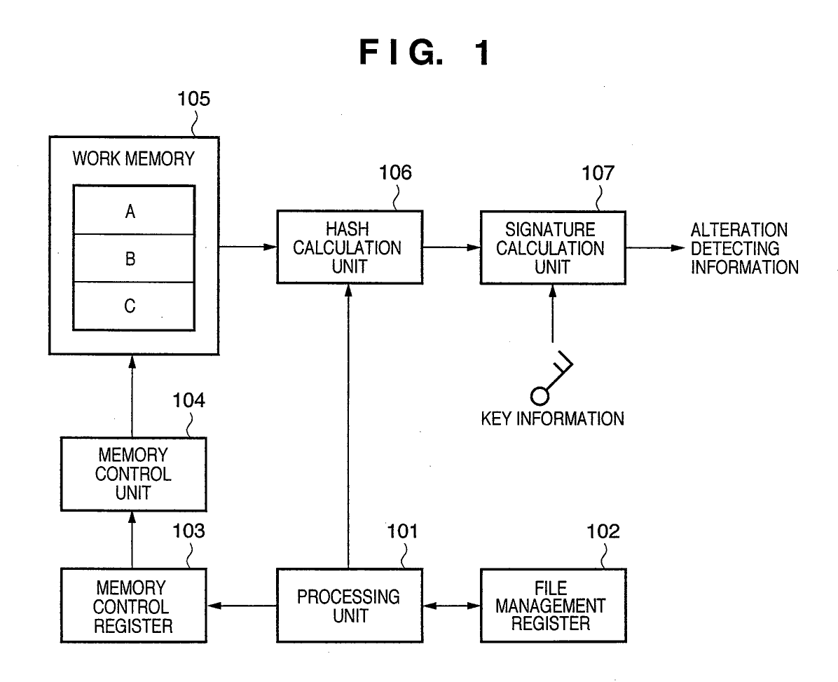

In the conventional control method described with reference to FIG. 1, digest processing is executed one-dimensionally for target image file data. In MD5 algorithm processing, four operations of hash calculation are executed per word to obtain digest values. Hash calculation executed by reading one word in a clock as hardware processing increases the processing time at least fourfold. Actually, 16 words each containing 32 bits are processed as a pair.

In the first exemplary embodiment, when the work memory 205 stores two or more target image file data, the processing unit 201 instructs to execute hash calculation and signature calculation. The number of target image file data has a default value in the digital camera, though the user may set an arbitrary value. Hence, the number of target image file data has no particularly fixed numerical value here. In the first exemplary embodiment, the two image file data A and B are processable as group image file data.

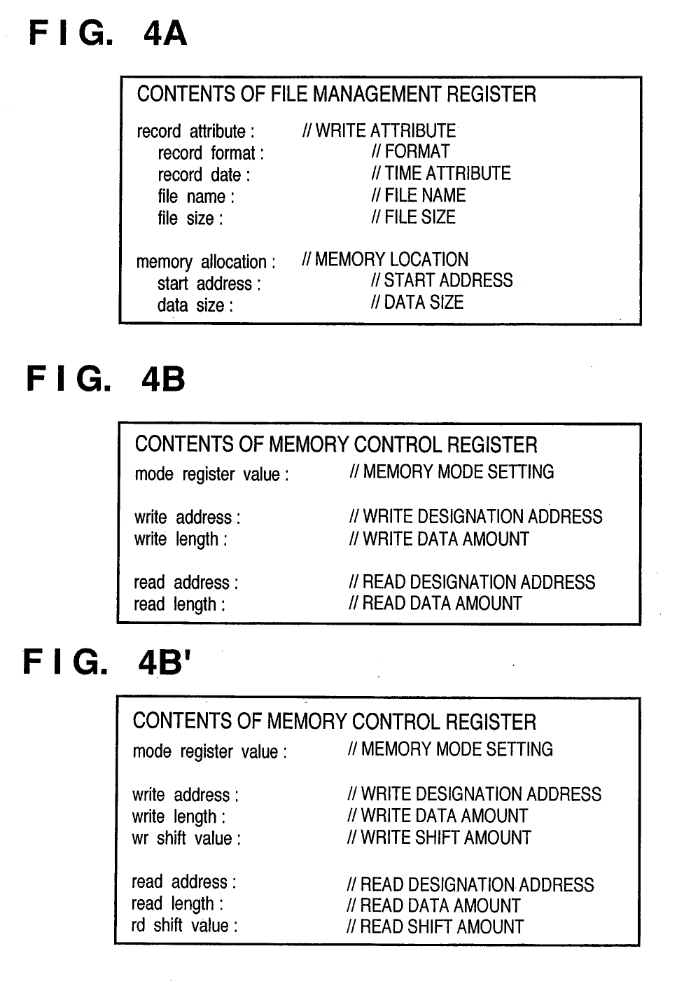

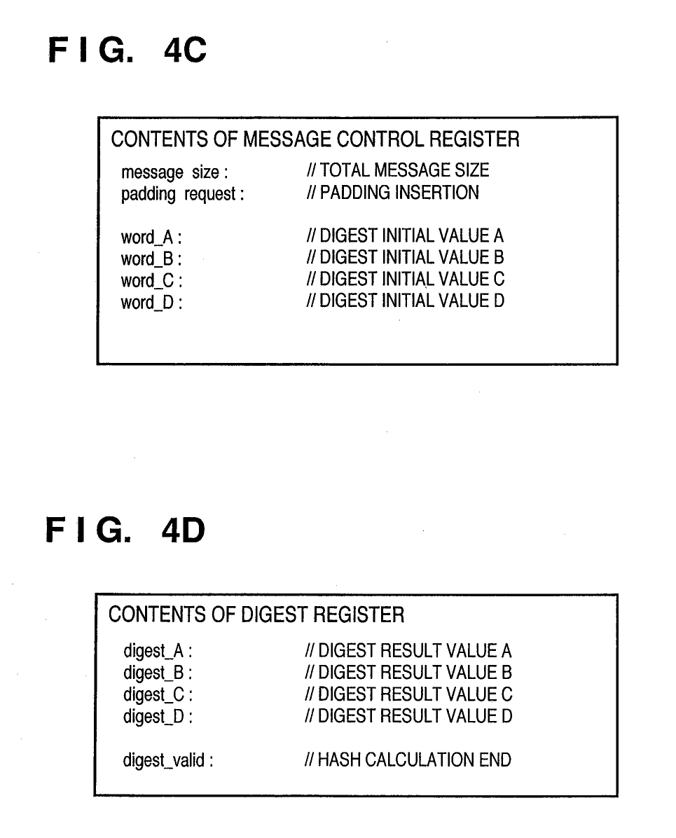

At the start of operation, the processing unit 201 reads out the contents of the file management register 202. FIG. 4A shows an example of the contents of the file management register 202. The file management register 202 has two pieces of main attribute information (write attribute information and memory location information). The write attribute information is related to file attributes and represents file contents independently of the state of the work memory 205. Memory location information indicates, for example, the storage location of image file data on the work memory 205. The file management register 202 places the two pieces of main attribute information of each of the image file data A and B into one record and manages a plurality of records corresponding to the number of image file data included in the target group image file data.

The file size and data size in the file management register 202 normally have equivalent values. If image file data is to be transmitted or received in structures on firmware, the convenience can be improved by independently defining the file size and data size. In this embodiment, they are defined independently. The file size and data size may be unified, as a matter of course. Data management is sometimes done in words. In this case, a difference corresponding to fractions of bytes may be generated between the actual value of data size and that of file size.

The processing unit 201 reads out the memory location information of image file data to be processed first and stores the information in the memory control register 203. FIG. 4B shows the set contents of the memory control register 203. For read control, the start address of the target image file data in the file management register 202 is set to the “read address” value in the memory control register 203. Additionally, the data size value is set to the “read length” value.

The mode register value in the memory control register 203 in FIG. 4B defines a work memory control operation. This corresponds to for example, a burst length set in the mode register of the SDRAM.

The processing unit 201 also calculates the sum of file sizes of all image file data included in the target group image file data. The calculated sum is called a total message size.

In the first exemplary embodiment, one digest value is calculated from the target group image file data including a plurality of image file data. Hence, the alteration detecting information generating unit 2 has a digest register 208 which temporarily holds a digest value as an output from the hash calculation unit 206, and a message control register 210 which instructs control to, for example, execute padding processing to the end. In the exemplary embodiments of the present invention, a “digest value” is also referred to as a “hash value”.

The message control register 210 holds the total message size, a padding request (flag) to instruct execution of padding, and digest initial values (FIG. 4C). Assume that a digest value include four word data. The initial values of the four words are word_A, word_B, word_C, and word_D.

The digest initial values are also set as the initial values in the digest register 208 shown in FIG. 2. FIG. 4D shows the contents of the digest register 208.

When initialization for hash calculation has finished, the processing unit 201 instructs the memory control unit 204 to start data readout from the work memory 205. The readout data is sent to the hash calculation unit 206 and handled as message data.

If the padding request flag in the message control register 210 is in the “N” state when a digest value of one image file data in the group image file data is calculated, the hash calculation unit 206 stops the operation and waits until input of the next image file data.

Upon detecting the end of data read based on an interrupt from the memory control unit 204, the processing unit 201 advances control to read processing of the next image file data. If the addresses of the plurality of image file data in the target group image file data continue on the work memory 205, the processing unit 201 may execute read processing by designating the total size to the memory control register 203. Control to update settings for each image file data will be described here.

In reading out the last image file data, the processing unit 201 sets the padding request of the message control register 210 to “N”. This enables obtaining a digest value calculated from the target group image file data in the digest register 208 at the end of image file data (message) read.

The digest value calculated from the target group image file data is provided from the digest register 208 to the signature calculation unit 209. The signature calculation unit 209 calculates signature information from the digest value using a digital signature algorithm. The signature information calculated by the signature calculation unit 209 is alteration detecting information in the first exemplary embodiment. The digest value is, for example, encrypted by key information 214 unique to the digital camera (e.g., a model name and serial number) and converted into the signature information.

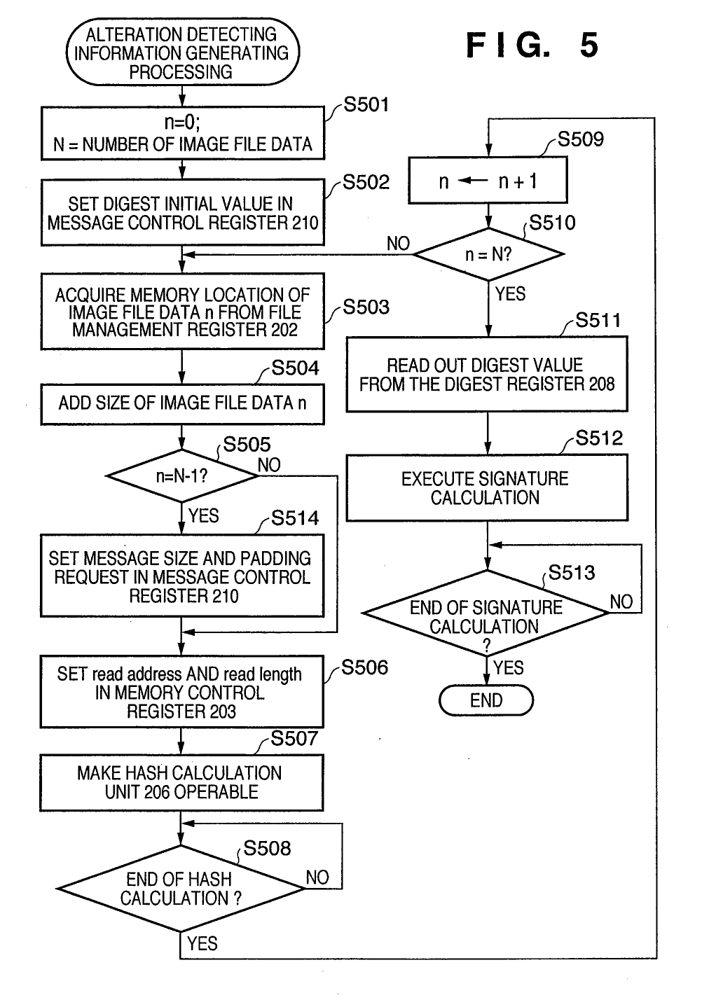

FIG. 5 is a flowchart for explaining the operation of the alteration detecting information generating unit 2 according to the first exemplary embodiment. In step S501, the processing unit 201 sets the total number N of image file data serving as a message and sets a numerical value n indicating image file data as a current processing target to an initial value (n=0). The total number N is the number of image file data included in target group image file data and can be defined by the user.

The process advances to step S502 to set a digest initial value in the message control register 210 to initialize the hash calculation unit 206.

In step S503, attribute information of first target image file data is read out from the file management register 202. In step S504, the file size of the target image file data is added to the total message size.

If the numerical value n does not satisfy n=N−1 in step S505, the process advances to step S506. The memory location information in the file attributes is set in the memory control register 203 as memory access information to the work memory 205. In this state, the hash calculation unit 206 is activated in step S507. The target image file data is provided from the work memory 205 to the hash calculation unit 206 via a FIFO buffer 207. The hash calculation unit 206 calculates a digest value from the target image file data, and the digest value to the digest register 208.

Upon detecting the end of processing by the hash calculation unit 206 in step S508, the processing unit 201 increments the processed file count n by one in step S509. If the processed file count n is less than the total number N of files to be processed, the process returns to step S503 to continue hash calculation.

In step S503, the file attributes of the next target image file data are read out. In step S504, the total message size is updated. If it is determined in step S505 that the target image file data is the final image file data to be processed (n=N−1), the process advances to step S514. The processing unit 201 sets the total message size in the total message size register of the message control register 210 and also sets a padding request flag. If hash calculation is executed in this state, the digest value of the group image file data is calculated, and hash calculation finishes. In step S511, the digest value is read out from the digest register 208 and provided to the signature calculation unit 209. In step S512, the signature calculation unit 209 calculates signature information from the digest value using a digital signature algorithm. The digest value is, for example, encrypted by the key information 214 and converted into the signature information. In step S513, if calculation of the signature information is completed, the processing is ended. After the calculation of the signature information is completed, the signature information is provided to a read/write unit 10. In the read/write unit 10, the signature information is, for example, attached to the end of the group image file data. The read/write unit 10 stores the signature information on the semiconductor memory card 4 together with the target group image file data. Then, the group image file data including the signature information can be taken out from the digital camera body.

### Second Exemplary Embodiment

FIG. 3 shows the second exemplary embodiment as another embodiment of the present invention. An arbitrary part of image file data is selected as partial image file data, and a digest value is generated from two or more partial image file data. The second exemplary embodiment is applicable not only to one image file data but also to a plurality of image file data, as in the first exemplary embodiment. The arrangement and operation of the second exemplary embodiment shown in FIG. 3 are the same as those of the first exemplary embodiment in many points, and a description thereof will not be repeated.

FIG. 4A shows the contents of a file management register 302 in FIG. 3. FIG. 4B′ shows the contents of a memory control register 303. FIG. 4C shows the contents of a message control register 310. FIG. 4D shows the contents of a digest register 308. These are merely examples, and the contents are not limited to those. Each register may be allocated on an arbitrary address in a work memory 305.

Assume that the work memory 305 shown in FIG. 3 stores image file data A, B and C respectively containing a sensed image. If a setting on the digital camera selects addition of alteration detecting information, a hash calculation unit 306 calculates a digest value from two or more partial image file data extracted from target image file data. A processing unit 301 in FIG. 3 acquires memory location information containing a start address and data size from the file management register 302.

The acquired memory location information is given to the memory control register 303 as memory access information. In the second exemplary embodiment, two or more partial image file data included in the target image file data is read out from the work memory 305, thereby shortening the alteration detecting information generation time and improving the throughput.

In the second exemplary embodiment, a random number generating unit 314 in FIG. 3 determines the position of each partial image file data included in the target image file data. The random number generating unit 314 generates, for example, a random number for the target image file data. The random number generation algorithm itself is not specified. To cause a PC (personal computer) to detect whether or not the target image file data is altered, the PC must execute the same hash calculation as described above. Hence, key information 315 is given here as a seed value to generate a random number.

The target image file data is thinned out in accordance with the result of random number generation. The thinning ratio is determined in consideration of the tradeoff between the throughput and the alteration detecting effect. If data is thinned out too much, the alteration detecting effect weakens. To complement the degradation of the alteration detecting effect by thinning, a check sum 312 in FIG. 3 may be used. The check sum 312 can be obtained from the target image file data.

The memory control register 303 sets a random number value received from the random number generating unit 314 in “rd shift value” in FIG. 4B′. The memory control unit 304 determines read addresses in accordance with the random number value so as to read out two or more partial image file data from the work memory 305. For example, if the work memory 305 is formed from an SDRAM, access to addresses that continue to some extent leads to concealment of latency of data (improvement of throughput). Hence, an amount that allows burst transfer to some degree may be read out continuously.

Two or more readout partial image file data is transferred to the hash calculation unit 306 via a FIFO buffer 307 and the hash calculation unit 306 calculates a digest value from two or more partial image file data. The message control register 310 in FIG. 3 sets the initial value for digest value calculation in the hash calculation unit 306. To process two or more partial image file data, the digest register 308 temporarily stores the digest value. The digest value is returned and used in inputting the next partial image file data (message data) to the hash calculation unit 306.

The digest register 308 stores the final digest value. For example, the processing unit 301 receives an interrupt from the memory control unit 304 and detects the end of data read. The processing unit 301 confirms based on a “digest_valid” flag in FIG. 4D, which exists in the digest register 308, that padding processing is ended, and the digest value is valid, and then inputs the digest value from the digest register 308 to a signature calculation unit 309. The signature calculation unit 309 calculates signature information from the digest value using a digital signature algorithm. The digest value is, for example, encrypted by the key information 315 and converted into the signature information. The signature information calculated by the signature calculation unit 309 is alteration detecting information in the second exemplary embodiment.

After the signature information is calculated, the signature information is provided to the read/write unit 10. In the read/write unit 10, the signature information is, for example, attached to the end of the target image file data. The read/write unit 10 stores the signature information on the semiconductor memory card 4 together with the image file data. Then, the image file data including the signature information can be taken out from the digital camera body.

In the first and second exemplary embodiments, a digital camera has the alteration detecting information generating unit 2. However, the present invention is not limited to a digital camera. The alteration detecting information generating unit 2 according to the first and second exemplary embodiments is applicable to devices for electronically recording an image, including an image capturing apparatus (e.g., a scanner), a medical electronic camera.

In the second exemplary embodiment, thinning is executed to derive two or more partial image file data by accessing the work memory 305 at an arbitrary interval by using the random number generating unit 314. However, a hash calculation target part may be selected from a fixed region of image file data. In this case, a region designation parameter is set in the memory control register 303. For example, image file data is divided into several strip-shaped regions, and regions that are not adjacent are selected as partial image file data. When image file data is horizontally divided into four parts, the first and third blocks counted from the top are selected. If image file data is color image file data, it may be divided into a luminance signal component (Y) and two color difference signals (R-Y and B-Y) or into three color signal components (R, G, and B). Many other dividing methods are also available, and the present invention is not limited to one of them.

The above-described embodiments can also be achieved by supplying a storage medium which records software program codes for implementing the functions of the above-described embodiments to a system or apparatus. That is, the above-described embodiments achieved by causing the computer (or CPU or MPU) of the system or apparatus to read out and execute the program codes stored in the storage medium. In this case, the program codes read out from the storage medium implement the functions of the above-described embodiments by themselves, and the storage medium which stores the program codes constitutes the present invention.

Examples of the storage medium to supply the program codes are a flexible disk, hard disk, optical disk, magnetooptical disk, CD-ROM, CD-R, magnetic tape, nonvolatile memory card, and ROM.

The functions of the above-described embodiments are implemented even when the OS (Operating System) running on the computer partially or wholly executes actual processing based on the instructions of the program codes.

In some cases, the program codes read out from the storage medium are written in the memory of a function expansion board inserted into the computer or a function expansion unit connected to the computer. The CPU of the function expansion board or function expansion unit partially or wholly executes actual processing based on the instructions of the program codes, thereby implementing the functions of the above-described embodiments.

While the present invention has been described with reference to exemplary embodiments, it is to be understood that the present invention is not limited to the disclosed exemplary embodiments. The scope of the following claims is to be accorded the broadest interpretation so as to encompass all modifications and equivalent structures and functions.

This application claims the benefit of Japanese Patent Application No. 2006-193232, filed Jul. 13, 2006, which is hereby incorporated by reference herein in its entirety.

What is claimed is:

1. An image sensing apparatus comprising:
an internal memory unit that stores a plurality of image data;
a random number generating unit that generates a random number;
a hash calculation unit that (a) extracts a plurality of partial image data from the plurality of image data, and (b) calculates a digest value from the plurality of partial image data extracted from the plurality of image data, before the plurality of image data stored in the internal memory unit are stored in a detachable memory unit, wherein a position of each partial image data is determined based on a result of random number generation;
an alteration detecting information generating unit that generates alteration detecting information from the digest value before the plurality of image data stored in the internal memory unit are stored in the detachable memory unit, wherein the alteration detecting information is used to detect whether or not the plurality of image data is altered; and
a storing unit that (a) attaches the alteration detecting information to the plurality of image data before the plurality of image data stored in the internal memory unit are stored in the detachable memory unit, and (b) stores the plurality of image data stored in the internal memory unit and the alteration detecting information attached to the plurality of image data in the detachable memory unit.

2. The image sensing apparatus according to claim 1, wherein the alteration detecting information generating unit generates the alteration detecting information from the digest value using a digital signature algorithm.

3. The image sensing apparatus according to claim 1, wherein the alteration detecting information generating unit encrypts the digest value using key information unique to the image sensing apparatus so as to generate the alteration detecting information.

4. The image sensing apparatus according to claim 1, wherein the image sensing apparatus is a digital camera.

5. A method of controlling an image sensing apparatus, the method comprising the steps of:
storing a plurality of image data in an internal memory unit included in the image sensing apparatus;
generating a random number;
extracting a plurality of partial image data from the plurality of image data, wherein a position of each partial image data is determined based on a result of random number generation;
calculating a digest value from the plurality of partial image data extracted from the plurality of image data, before the plurality of image data stored in the internal memory unit are stored in a detachable memory unit;
generating alteration detecting information from the digest value before the plurality of image data stored in the internal memory unit are stored in the detachable memory unit, wherein the alteration detecting information is used to detect whether or not the plurality of image data is altered;
attaching the alteration detecting information to the plurality of image data before the plurality of image data stored in the internal memory unit are stored in the detachable memory unit; and
storing the plurality of image data stored in the internal memory unit and the alteration detecting information attached to the plurality of image data in the detachable memory unit.

6. The method according to claim 5, wherein the alteration detecting information is generated from the digest value using a digital signature algorithm.

7. The method according to claim 5, further comprising a step of encrypting the digest value using key information unique to the image sensing apparatus so as to generate the alteration detecting information.

8. The method according to claim 5, wherein the image sensing apparatus is a digital camera.

9. The image sensing apparatus according to claim 1, wherein the number of the plurality of image data is set by a user.

10. The method according to claim 5, wherein the number of the plurality of image data is set by a user.
